(19) United States
(12) Patent Application Publication
(10) Pub. No.: US 2012/0313270 A1
(43) Pub. Date: Dec. 13, 2012

(54) MODIFIED INJECTION MOLDING UNIT AND METHOD OF DELIVERING COOLED MOLDING MATERIAL

(75) Inventors: Michael Wallick, Warsaw, IN (US); Brian H. Thomas, Lakeland, FL (US); Brion R. Mimnaugh, Warsaw, IN (US)

(73) Assignee: Zimmer, Inc., Warsaw, IN (US)

(21) Appl. No.: 13/444,574

(22) Filed: Apr. 11, 2012

Related U.S. Application Data
(60) Provisional application No. 61/474,353, filed on Apr. 12, 2011.

(51) Int. Cl. B29C 45/72

(52) U.S. Cl. 264/28; 425/547

(57) ABSTRACT

Injection molding units and methods of delivering a cooled molding material to portions of an injection molding unit are disclosed. An injection molding unit can comprise a barrel having a feed zone, a feeding portion configured for dispensing a molding material into the feed zone, and a cooling apparatus configured for cooling at least one of the feed zone or the feeding portion to a temperature that is selected to avoid or reduce bridging or obstruction of the molding material. The cooling apparatus can include a jacket configured to cover at least a portion of the feed zone or the feeding portion. The injection molding unit can further comprise an insulation shield. A method can comprise feeding the molding material into the feed zone and cooling the molding material prior to dispensing it into the feed zone or while it is in the feed zone.

### CLAIM OF PRIORITY

This application claims the benefit of priority under 35 U.S.C. §119(e) of Wallick et al., U.S. Provisional Patent Application Ser. No. 61/474,353, entitled “MODIFIED INJECTION MOLDING UNIT AND METHOD OF DELIVERING COOLED MOLDING MATERIAL,” filed on Apr. 12, 2011, which is herein incorporated by reference in its entirety.

### TECHNICAL FIELD

This patent document pertains generally to injection molding and, more specifically, to a cooling apparatus or insulation shield for an injection molding unit. This patent document also pertains to a method for delivering a cooled molding material into a feed zone of an injection molding unit.

### BACKGROUND

Injection molding units can include a hopper, a barrel, a screw, and a nozzle. A molding material, which can be a resin in pellet form, can be fed from the hopper through a feed throat and into a feed zone of the barrel, such as into flights of the screw positioned within the barrel.

### SUMMARY

Depending upon a composition of a molding material fed into an injection molding unit, there can be scenarios where a surrounding environment in combination with characteristics of the molding material causes the molding material to be wet, softened, or partially melted, such that the pellets couple or adhere to one another to form bridges, also known as obstructions. These bridges or obstructions can form within a hopper or within a feed throat before the pellets are able to reach a screw of the injection molding unit, and can thereby prevent or hinder the feeding of the molding material to a mold.

Previously, this problem has been attempted to be addressed through drying or otherwise removing moisture from the molding material before it is placed within the hopper. However, the present inventors have recognized, among other things, that simply removing moisture from some hygroscopic or hydrophilic molding materials (e.g., materials that rapidly absorb moisture from the air) before they have been placed within the hopper will not sufficiently address the bridging or obstruction problem. The composition of these molding materials is such that they can wet, soften, or melt during the relatively short time that the materials are within the hopper or feed throat.

The present injection molding units and methods are configured to prepare and deliver a cooled molding material to an injection molding unit to avoid or reduce flow-inhibiting bridging or obstruction within one or more portions of the injection molding unit. An injection molding unit can comprise a barrel having a feed zone, a feeding portion configured for dispensing a molding material into the feed zone, and a cooling apparatus configured for cooling at least one of the feed zone or the feeding portion based on a programmable or sensed temperature. The programmable or sensed temperature can be selected to avoid or reduce flow-inhibiting bridging or obstruction of the molding material within the feed zone or the feeding portion, for example. The cooling apparatus can include a jacket configured to cover at least a portion of the feed zone or the feeding portion. The injection molding unit can further comprise an insulation shield. A method can comprise feeding the molding material into the feed zone and cooling the molding material prior to dispensing it into the feed zone or while it is in the feed zone.

To better illustrate the injection molding units and methods of delivering a cooled molding material disclosed herein, a non-limiting list of examples is now provided:

In Example 1, an injection molding unit comprises a barrel having a feed zone, a feeding portion configured for dispensing a molding material into the feed zone, and a cooling apparatus configured for cooling at least one of the feed zone or the feeding portion to a temperature that is selected to avoid or reduce bridging or obstruction of the molding material within the feed zone or the feeding portion.

In Example 2, the injection molding unit of Example 1 is optionally configured such that the temperature is based on a programmed or sensed temperature of the cooling apparatus, the feed zone, or the feed portion.

In Example 3, the injection molding unit of any one of Examples 1 and 2 is optionally configured such that the temperature is based on a programmed or sensed temperature of the cooled molding material.

In Example 4, the injection molding unit of any one of Examples 1-3 is optionally configured such that the temperature is at or below about 0° C.

In Example 5, the injection molding unit of any one of Examples 1-4 is optionally configured such that the cooling apparatus includes a jacket configured to cover at least a portion of the feed zone or the feeding portion.

In Example 6, the injection molding unit of Example 5 is optionally configured such that the jacket comprises a sleeve at least partially filled with a cooling medium.

In Example 7, the injection molding unit of Example 6 is optionally configured such that the cooling medium comprises a fluid that is circulated within the sleeve.

In Example 8, the injection molding unit of any one of Examples 5-7 is optionally configured such that the jacket is configured to cover a hopper of the feeding portion, which is sized and shaped to hold the molding material.

In Example 9, the injection molding unit of Example 8 is optionally configured such that the cooling apparatus is configured to cool at least a portion of the hopper to the temperature sufficient to avoid or reduce bridging or obstruction of the molding material within the hopper or within the feed zone.

In Example 10, the injection molding unit of any one of Examples 5-9 is optionally configured such that the jacket is configured to cover a feed throat of the feeding portion.

In Example 11, the injection molding unit of any one of Examples 1-10 is optionally configured such that the feeding portion comprises a first hopper, and wherein the cooling apparatus comprises a second hopper within the first hopper configured and sized for mixing a cooling medium with the molding material.

In Example 12, the injection molding unit of Example 11 optionally further comprises a conveying device to move cooled molding material from the second hopper into a cavity within the first hopper.

In Example 13, the injection molding unit of any one of Examples 1-12 optionally further comprises an insulation shield positioned between the feeding portion and a metering zone of the barrel.

In Example 14, the injection molding unit of Example 13 is optionally configured such that the insulation shield separates the feed zone of the barrel and the metering zone of the barrel.

In Example 15, a method comprises feeding a molding material into a feed zone of an injection molding unit, and cooling the molding material to a temperature, sufficient to avoid or reduce bridging or obstruction of the molding material within a portion of the injection molding unit, prior to dispensing the molding material into the feed zone or while the molding material is in the feed zone.

In Example 16, the method of Example 15 is optionally configured such that cooling of the molding material includes cooling at least one of a feeding portion of the injection molding unit or the feed zone to a temperature at or below the cooled temperature of the molding material.

In Example 17, the method of Example 16 is optionally configured such that cooling of the molding material includes cooling one or both of a hopper or a feed throat of the feeding portion.

In Example 16, the method of any one of Examples 15-17 is optionally configured such that cooling the molding material to the temperature includes cooling the molding material to a temperature at or below about 0° C.

In Example 18, the method of any one of Examples 15-17 is optionally configured such that cooling the molding material includes mixing a cooling medium with the molding material.

In Example 19, the method of Example 18 optionally further comprises separating the cooling medium and the cooled molding material prior to feeding the molding material into the feed zone.

In Example 20, the method of either of Example 18 or 19 is optionally configured such that mixing the cooling medium with the molding material includes mixing liquid nitrogen with the molding material.

In Example 21, the method of any of Examples 18-20 is optionally configured such that mixing the cooling medium with the molding material occurs in a first hopper of the injection molding unit.

In Example 22, the method of Example 21 is optionally configured such that the first hopper is positioned within a second hopper, and the method optionally further comprises conveying cooled molding material from the first hopper into a cavity within the second hopper.

In Example 23, the injection molding unit or method of any one or any combination of Examples 1-22 is optionally configured such that all elements or options recited are available to use or select from.

These and other examples and features of the present injection molding units and methods will be set forth, in part, in the following detailed description. This summary is intended to provide an overview, including non-limiting examples, of subject matter disclosed in this patent document. It is not intended to provide an exclusive or exhaustive explanation of the present injection molding units and methods. The following detailed description is included to provide further information about the present injection molding units and methods.

### BRIEF DESCRIPTION OF THE DRAWINGS

In the drawings, like numerals can be used to describe similar elements throughout the several views. The drawings illustrate generally, by way of example, but not by way of limitation, various embodiments discussed in the present document.

FIG. 1 illustrates a schematic view of an injection molding unit and a cooling system, as constructed in accordance with at least one embodiment.

FIG. 2 illustrates a schematic view of a portion of an injection molding unit and a cooling system, as constructed in accordance with at least one embodiment.

FIG. 3 illustrates a schematic view of a portion of an injection molding unit and a cooling system, as constructed in accordance with at least one embodiment.

FIG. 4 illustrates a method of delivering a cooled molded material to an injection molding unit, as constructed in accordance with at least one embodiment.

The present disclosure illustrates examples that are not to be construed as limiting the scope of the claims set forth herein in any manner.

### DETAILED DESCRIPTION

A cooling apparatus can be included in an injection molding unit and used to cool a molding material within a feeding portion or a feed zone of a barrel of the injection molding unit. The cooling apparatus can maintain the feeding portion or the feed zone of the injection molding unit at a temperature that is selected to avoid or reduce flow-inhibiting bridging of the molding material within the feeding portion or the feed zone.

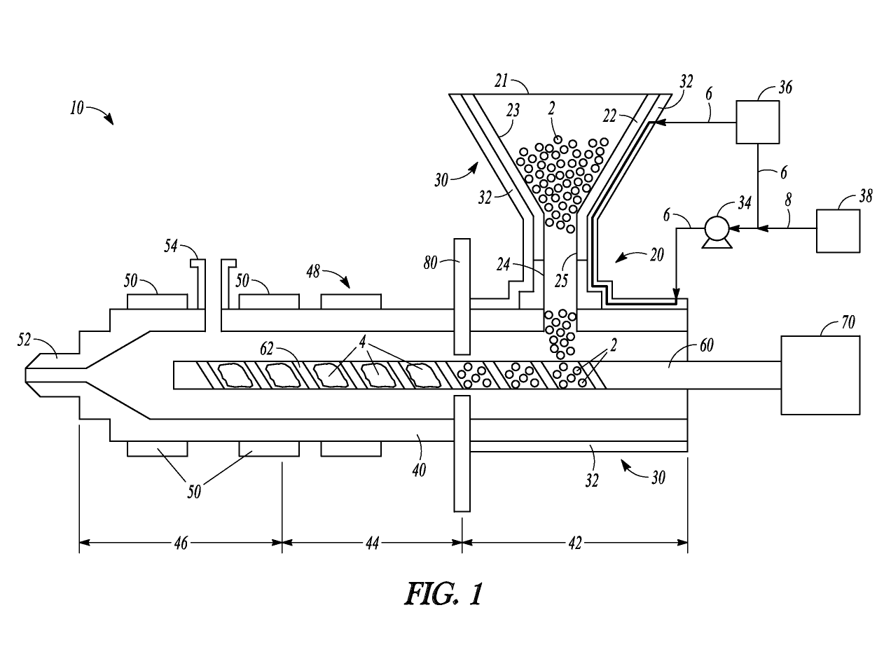

FIG. 1 illustrates an example of an injection molding unit 10 including a feeding portion 20, a cooling apparatus 30, a barrel 40, an injection screw 60, and a motor 70. These elements can interact to deliver an injectable molding material 2 into a mold.

The feeding portion 20 can charge, feed, or otherwise supply the molding material 2 into the barrel 40. The molding material 2 can be in the form of pellets or particles, such as a resin in pellet or particle form. The feeding portion 20 can include a hopper 22 and a feed throat 24. The hopper 22 can be a container that receives the molding material 2 and temporarily holds the molding material 2 before it is fed into the feed throat 24 and ultimately into the barrel 40 of the injection molding unit 10. The hopper 22 can include a funnel-shaped container that has an opening 21 to receive the molding material 2. The opening 21 can lead to a tapered throat 23 that urges the molding material 2 out of an opening 25 defined in a bottom portion of hopper 22. The hopper 22 can be sized and shaped to hold any desired amount of the molding material 2. For example, the hopper 22 can be sized and shaped for a single shot of molding material 2 or can be sized and shaped to contain a plurality of molding material 2 shots.

The feed throat 24 can be a passageway that leads into the barrel 40. The feed throat 24 can connect the hopper 22 to the barrel 40, however, the hopper 22 can be omitted and the molding material 2 can be manually or otherwise fed into the feed throat 24. Also, the hopper 22 and the feed throat 24 can be integrally formed. In addition, the feeding portion 20 can also include additional structures or components, such as one or more of a refrigeration unit, a dryer, or a conveyor.

The injection screw 60 can be positioned or mounted within the barrel 40 and can be configured to be rotated or otherwise moved, for example plunged, within the barrel 40 by the motor 70. The injection screw 60 can include a number of flights 62 that can be used to receive and advance the molding material 2 through the injection molding unit 10, such as through the barrel 40. It will be appreciated that other injection screw configurations can be used in the injection molding unit 10, depending upon the specifics of the molding material 2 being used and other desired or selected factors.

The barrel 40 can be divided into one or more zones. In an example, the barrel 40 is divided into three zones: a feed zone 42, a melt zone 44, and a metering zone 46. Each of the zones 42, 44, 46 can be operated at a different temperature. In some applications, the temperature difference between adjacent zones 42, 44, 46 can be significant. A heater 48 can surround one or more zones of the barrel 40, such as the melt zone 44 or the metering zone 46, or both, in order to heat and ultimately melt the molding material 2 to form a molten molding material 4, and to keep the molten molding material 4 in a liquid or molten state while the molding material 4 is within the remainder of the melt zone 44 and the metering zone 46, or both. The heater 48 can include a plurality of external electric heating bands 50 that surround at least a portion of the barrel 40. Other forms of heaters can also or alternatively be used with the injection molding unit 10.

A nozzle 52 can be positioned at an end of the metering zone 46 of the barrel 40. The nozzle 52 can be in fluid communication with a mold such that the molten molding material 4 can be injected into the mold in order to allow molding to be completed. The barrel 40 can also include one or more vents 54 within the melt zone 44, the metering zone 46, or both. Depending on the molding material 4 used, the vent 54 can allow water vapor, volatiles, and any other fluid, such as a gas, to escape from the barrel 40. The number and placement of the vents 54 can vary and not depart from the spirit and scope of the present disclosure.

As noted previously, the temperature difference between each of the zones 42, 44, 46 of the barrel 40 can be significant. The temperature in the feed zone can be low enough to keep the molding material 2 in a solid state (e.g., in a solid pellet or particulate form). In an example, the molding material 2 can comprise a hygroscopic or hydrophilic material that can become compressible or tacky at, about, or above room temperature. Such a molding material 2 can become hard or non-tacky when cooled below a particular programmable temperature, such that the pellets or particles of the molding material 2 can be less likely to conglomerate and form bridging or obstruction of the feeding portion 20 or the feed zone 42 of the barrel 40. The temperature in the metering zone 46 can be sufficiently high to keep the molten molding material 4 in a melted state and at a viscosity that is sufficiently low in order to fill the mold without completely freezing off. The temperature in the melt zone 44 of the barrel 40 can be intermediate to the temperature in the feed zone 42 and the temperature in the metering zone 46 in order to allow the molding material 2 to start to melt and consolidate. In an example, adjacent zones 42, 44, 46 of the barrel 40 can have temperature differences of from 15° C. to 30° C. (from 60° F. to 80° F.).

There are certain molding materials that can benefit from even more significant temperature differences between the zones, and in particular between the feed zone 42 and the melt zone 44. Examples of a material that can benefit from a large temperature difference are hygroscopic or hydrophilic materials. In an example, extremely hygroscopic molding materials can be used that benefit from large temperature differences.

As discussed above, some materials, such as hygroscopic materials, may be prone to bridging or obstuction. In order to reduce the risk of the bridging or obstruction, it has been found that lowering the temperature of the molding material 2 before the molding material 2 enters the feed zone 42 or while the molding material is in the feed zone 42, or both, can reduce the likelihood of bridging of the molding material 2. In an example, the molding material 2 can be cooled before the molding material 2 enters the flights 62 of injection screw 60.

Lowering the temperature of the molding material 2 can be accomplished by controlling the temperature of the feeding portion 20, or by controlling the temperature of the feed zone 42 of the barrel 40, or both. With some extremely hygroscopic materials, the feed zone 42 or the feeding portion 20, or both, can be cooled to at or below about 15.5° C. (about 60° F.), to at or below about 10° C. (about 50° F.), or to at or below about 0° C. (about 32° F.), for example. When the molding material 2 in the feed zone 42 or the feeding portion 20, or both, is at the reduced temperature, the temperature of the melt zone 44 can be raised to above about 65° C. (about 150° F.) in order to sufficiently melt the molding material 2 to form a molten molding material 4 in the melt zone 44.

In order to lower the temperature of the feeding portion 20, the feed zone 42, or both, the injection molding unit 10 can include the cooling apparatus 30. The cooling apparatus 30 can help maintain a desired or programmed temperature in the feed zone 42 of the barrel 40, or in the feeding portion 20, or both.

As illustrated in FIG. 1, the cooling apparatus 30 can include a jacket 32 that covers or surrounds at least a portion of the feed zone 42 of the barrel 40, or at least a portion of the feeding portion 20, or both. The jacket 32 can be a sleeve filled with a cooling medium, such as a cooling liquid or a cooling gas (e.g., glycol, liquid nitrogen, liquid argon, or any other suitable cooling medium that can obtain a desired or programmed temperature to avoid or reduce bridging of the molding material 2). Alternatively, the jacket 32 can include piping or tubing that wraps around or surrounds a portion of the feed zone 42 of the barrel 40 or the feeding portion 20, or both, with a cooling medium filling or flowing through the piping or tubing to cool the molding material 2 in the feed zone 42 or the feeding portion 20, or both.

The jacket 32 can be formed separate from the feeding portion 20 or the feed zone 42 of the barrel 40 and selectively applied to the outside of the feeding portion 20 or the feed zone 42 of the barrel 40, or both. Alternatively, the jacket 32 can be constructed on or within the feeding portion 20 or the feed zone 42 of the barrel 40, or both, such as by being integrally constructed with the feeding portion 20, with the feed zone 42 of the barrel 40, or both. In an example, the hopper 22 can be formed with a double wall such that the cooling medium can flow freely within a plenum formed within the double wall. Alternatively, the piping or tubing for carrying the cooling medium can be run through the double wall.

The jacket 32 does not need to entirely cover the feeding portion 20, the feed zone 42 of the barrel 40, or both. The jacket 32 can surround one or more selected portions of the feeding portion 20, the feed zone 42, or both, and still sufficiently cool the molding material 2 to the desired or programmed temperature. In addition, the jacket 32 can cover part of or the entire feeding portion 20, or can cover part of or the entire feed zone 42 of the barrel 40, or both. In an example where the jacket 32 only covers the feeding portion 20, the jacket 32 can cover the hopper 22, the feed throat 24, or both.

As mentioned above, the cooling apparatus 30 can incorporate a cooling medium. The cooling medium can be moved or circulated through the jacket 32 using a pump 34 or other means to move the cooling medium. The cooling medium can be continuously circulated through the jacket. For example, a glycol cooling medium 6 can be circulated by the pump 34 into the jacket 32, through the jacket 32, and then out of the jacket 32 to a re-cooling mechanism 34, such as a condenser. The re-cooled cooling medium 6 can then be re-circulated into the jacket 32. Alternatively, fresh cooling medium 8 can be continuously pumped, such as from a fresh cooling medium storage tank 38, into and through the jacket 32, or fresh cooling medium 8 can be mixed with the re-cooled or re-circulated cooling medium 6, or a portion of the re-cooled or re-circulated cooling medium 6, as shown in FIG. 1.

The cooling apparatus can include more than one jacket. Each of the jackets does not need to share or use the same cooling medium. For example, a first jacket covering the feeding portion can use a first cooling medium, and a second jacket covering the feed zone of the barrel can use a second cooling medium. In addition, two or more different types of cooling jackets, for example a sleeve and one or more pipes, can be used within the same injection molding unit, such as a first type of cooling jacket for cooling the feeding portion and a second type of cooling jacket for cooling the feed zone of the barrel.

The cooling apparatus 30 can include a controller to control (e.g., program) or monitor (e.g., sense) the temperature of the cooling medium or the temperature of selected portions of the injection molding unit 10, such as the hopper 22 or other portions of the feeding portion 20, or the feed zone 42 of the barrel 40. Accordingly, the controller can selectively or automatically change different characteristics, such as, but not limited to, the specific cooling medium used, the cooling medium flow rate, or the cooling medium temperature, depending upon different characteristics sensed by sensors in communication with the controller, or based on other variables. Alternatively, the controller can simply be controlled by a user.

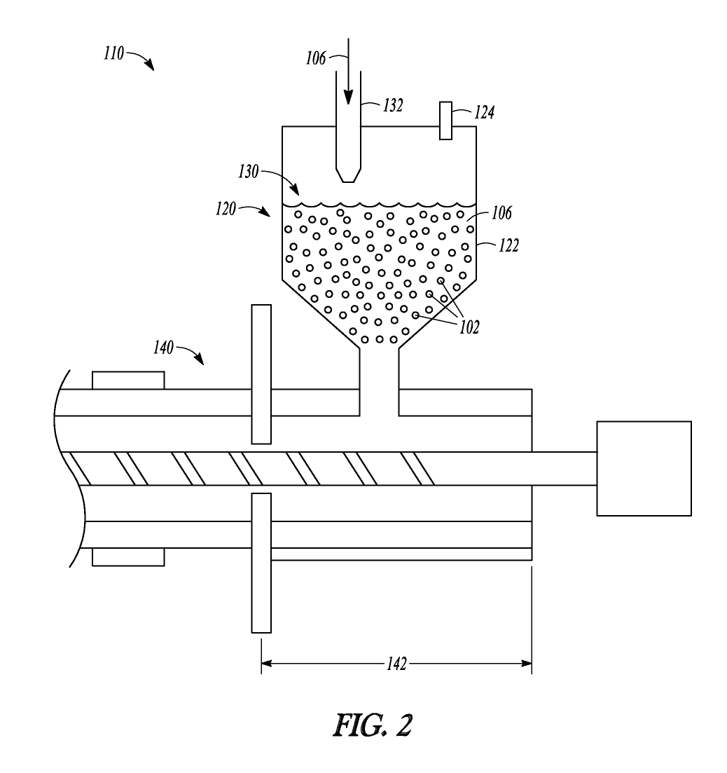

FIG. 2 illustrates an injection molding unit 110 that includes another example of a cooling apparatus 130. The cooling apparatus 130 of the injection molding unit 110 can include a cooling medium injector 132 that can inject a cooling medium 106 so that the cooling medium 106 can be in contact with the molding material 102 in order to lower the temperature of the molding material 102. The cooling medium injector 132 can inject the cooling medium 106 into a feeding portion 120 of the injection molding unit 110, such as into a hopper 122. The hopper 122 can then feed the cooled molding material 102 to a feed zone 142 of a barrel 140.

In an example, the cooling medium 106 that is injected by the cooling medium injector 132 is a liquified form of a compound that is ordinarily gaseous at room temperature, such as liquid nitrogen or liquid argon. The cooling medium injector 132 can direct the cooling medium 106 directly into the interior of the hopper 122 where the molding material 102 is positioned, such that the cooling medium 106 interacts, or mixes, with the molding material 102. The hopper 122 can be covered or otherwise sealed in order to prevent or reduce unwanted release of the cooling medium 106 and also to reduce or minimize air intrusion into the hopper 122. The hopper 122 can include a pressure release valve 124 in order to relieve any pressure buildup that can result from the liquefied cooling medium 106 evaporating into a gaseous form, such as nitrogen gas from a liquid nitrogen cooling medium. The release of the gas can avoid damage to the hopper 122 and other structures of the injection molding unit 110, and can maintain the contents of the hopper 122 at a depressed temperature.

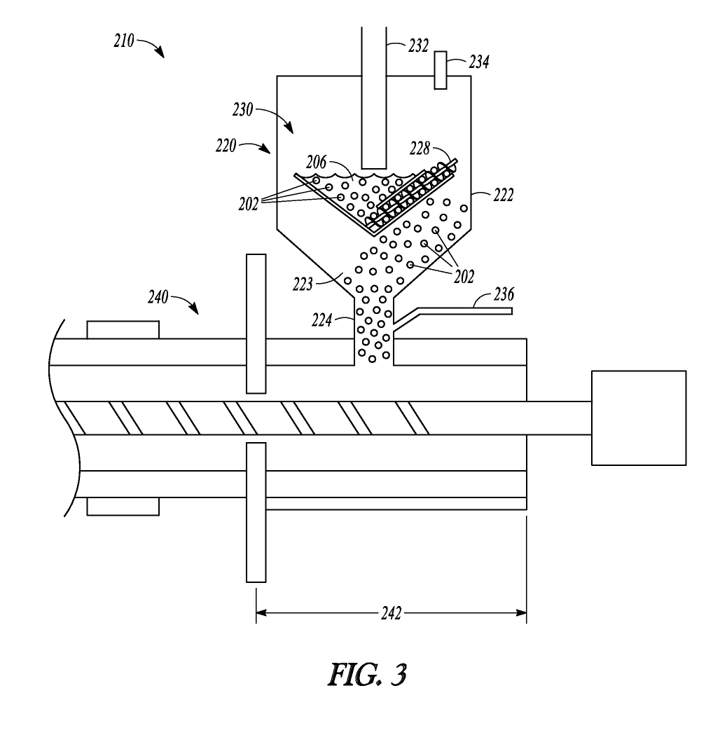

FIG. 3 illustrates an injection molding unit 210 that includes another example of a cooling apparatus 230. Similar to the cooling apparatus 130 shown in FIG. 2, the cooling apparatus 230 can include a main hopper 222 that feeds a molding material 202 to a feed zone 242 of a barrel 240. Within the main hopper 222 can be a smaller container 226, such as a small hopper 226, into which a molding material 202 and a cooling medium 206 can be fed. The cooling medium 206, the molding material 202, or both, can be fed into the small hopper 226 through a feed inlet or injector 232. As with the cooling medium 106 used in the cooling apparatus 130 of FIG. 2, the cooling medium 206 of the cooling apparatus 230 can be a liquefied form of a compound that is ordinarily gaseous at room temperature, such as liquid nitrogen or liquid argon. The small hopper 226 can be configured so that a particular pellet or particle of molding material 202 remains mixed with the cooling medium 206 for a desired residence time, after which time the pellet or particle of molding material 202 can be moved into the main hopper 222 in order to be fed into the barrel 240.

A conveying device 228, such as a screw or conveyor belt, can move pellets or particles of the molding material 202 from a position within the small hopper 226, such as the bottom of the small hopper 226, out of the small hopper 226 and into a cavity 223 of the main hopper 222. The conveying device 228 can be positioned so that it only collects molding material 202 from a specific point in the small hopper 226, such as from the bottom of the small hopper 226, so that the molding material 202 will be cooled by its settling in the cooling medium 206 toward the bottom of the small hopper 226.

Like the hopper 122 of the cooling mechanism 130 shown in FIG. 2, the main hopper 222, the small hopper 226, or both can be covered or sealed. The main hopper 222, the small hopper 226, or both can also have a pressure release valve 234 to prevent the buildup of pressure in the main hopper 222 or the small hopper 226.

In an example, such as is shown in FIG. 3, the cooling apparatus 230 can comprise a cooling air inlet tube 236 for cooling of the molding material 202 within the feeding portion 220, such as within a feed throat 224 leading from the hopper 222 to the feed zone 242 of the barrel 240. Chilled air can be fed through the inlet tube 236 in order to further cool the molding material 202 before it is fed into the barrel 240. The chilled air can be dry, e.g., substantially free of moisture, or with a moisture content that is less than a moisture content of the molding material 202, so that additional moisture will not be absorbed by the molding material 202 within the feed throat 224. The flow rate of the chilled air should be relatively high without causing a backup of the pellets or particles of the molding material due to the pellets or particles becoming entrained in the chilled air flow.

Returning to the injection molding unit 10 shown in FIG. 1, the injection molding unit 10 can include an insulation shield 80 positioned at a location along the length of the barrel 40. The insulation shield 80 can be positioned between the feeding portion 20 or the feed zone 42 and the heaters 48. For example, the insulation shield 80 can be positioned between the feed zone 42 and the melt zone 44. The insulation shield 80 can be positioned elsewhere, such as entirely within the feed zone 42. The insulation shield 80 can be constructed of a material having sufficient or desired insulative properties, such as a ceramic material. The insulation shield 80 can pass through the barrel 40, but not the injection screw 60, and can extend outwardly from the barrel 40. The distance the insulation shield 80 extends outwardly can depend upon the heat insulation desired and the surrounding environment. The insulation shield 80 can also be positioned within the barrel 40 and not extend outwardly.

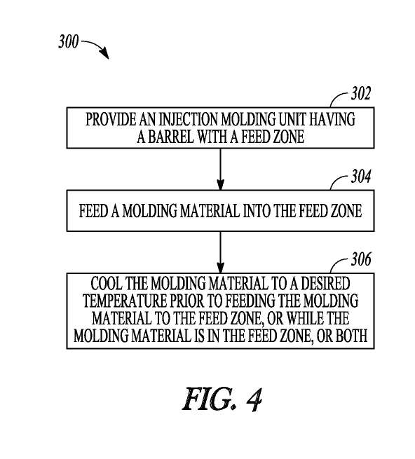

The present subject matter also includes a method of delivering a cooled molding material to an injection molding unit or to a portion of the injection molding unit. FIG. 4 illustrates an example of such a method 300. At 302, an injection molding unit including a barrel with a feed zone can be provided or obtained. At 304, a molding material can be fed into the feed zone. The injection molding unit can include a feeding portion configured for funneling and urging the molding material into the feed zone.

At 306, the molding material can be cooled to a desired or programmed temperature either prior to feeding the molding material to the feed zone, or while the molding material is in the feed zone, or both. Cooling the molding material can include cooling a feeding portion or the feed zone, or both, with a cooling jacket that is positioned proximate or around the feed portion, the feed zone, or both. The feed jacket can be cooled with a cooling medium that can fill the feed jacket or be circulated through the feed jacket.

In another example, cooling the molding material can include mixing a cooling medium, such as liquid nitrogen, with the molding material to form a mixture. The cooling medium can be introduced to the molding material through a cooling medium injector. The molding material and the cooling medium can be mixed in a hopper and then fed into the feed zone of the barrel. After mixing the cooling medium and the molding material, the cooling medium and the molding material can be separated, such as by allowing a liquid nitrogen cooling medium to evaporate. The separated and cooled molding material can be fed into the feed zone.

In another example, cooling the molding material can include contacting the molding material with a chilled air, such as at a feed throat prior to feeding the molding material into the feed zone of the barrel.

The above detailed description includes references to the accompanying drawings, which form a part of the detailed description. The drawings show, by way of illustration, specific embodiments in which the present injection molding units and methods can be practiced. These embodiments are also referred to herein as “examples.” The embodiments and examples can include elements in addition to those shown or described. However, the present inventors also contemplate embodiments and examples in which only those elements shown or described are provided. Moreover, the present inventors also contemplate embodiments and examples using any combination or permutation of the elements shown or described (or one or more aspects thereof), either with respect to a particular embodiment or example (or one or more aspects thereof), or with respect to other embodiments or examples (or one or more aspects thereof) shown or described.

In the event of inconsistent usages between this document and any document so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” In this document, the phrase “extremely hygroscopic” or similar can refer to a material that is more hygroscopic than nylon or that will absorb moisture faster than nylon, or both.

In the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method embodiments and examples described herein can be machine or computer-implemented, at least in part. Some embodiments and examples can include a computer-readable medium or machine-readable medium encoded with instructions operable to configure an electronic device to perform methods as described in the above embodiments and examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above detailed description is intended to be illustrative, and not restrictive. For example, the above-described embodiments and examples (or one or more aspects thereof) may be used in combination with each other. Other embodiments and examples can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above detailed description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the detailed description as examples or embodiments, with each claim standing on its own as a separate embodiment, and it is contemplated that such embodiments can be combined with each other in various combinations or permutations. The scope of the present injection molding units and methods should be determined with reference to the appended claims, along with the full scope of equivalents to which such claims are entitled.

What is claimed is:

1. An injection molding unit, comprising:
a barrel having a feed zone;
a feeding portion configured for dispensing a molding material into the feed zone; and
a cooling apparatus configured for cooling at least one of the feed zone or the feeding portion to a temperature that avoids or reduces bridging or obstruction of the molding material within the feed zone or the feeding portion.

2. The injection molding unit of claim 1, wherein the temperature is based on a programmed or sensed temperature of the cooling apparatus, the feed zone, the feed portion, or the cooled molding material.

3. The injection molding unit of claim 1, wherein the temperature is at or below about 0° C.

4. The injection molding unit of claim 1, wherein the cooling apparatus includes a jacket configured to cover at least a portion of at least one of the feed zone or the feeding portion.

5. The injection molding unit of claim 4, wherein the jacket comprises a sleeve at least partially filled with a cooling medium.

6. The injection molding unit of claim 5, wherein the cooling medium comprises a fluid that is circulated within the sleeve.

7. The injection molding unit of claim 4, wherein the jacket is configured to cover a hopper of the feeding portion, the hopper being sized and shaped to hold the molding material.

8. The injection molding unit of claim 4, wherein the jacket is configured to cover a feed throat of the feeding portion.

9. The injection molding unit of claim 1, wherein the feeding portion comprises a first hopper, and wherein the cooling apparatus comprises a second hopper within the first hopper configured and sized for mixing a cooling medium with the molding material.

10. The injection molding unit of claim 9, further comprising a conveying device to move cooled molding material from the second hopper into a cavity within the first hopper.

11. The injection molding unit of claim 1, further comprising an insulation shield positioned between the feeding portion and a metering zone of the barrel.

12. The injection molding unit of claim 11, wherein the insulation shield separates the feed zone of the barrel and the metering zone of the barrel.

13. A method, comprising:
feeding a molding material into a feed zone of an injection molding unit; and
cooling the molding material to a temperature, selected to avoid or reduce bridging or obstruction of the molding material within a portion of the injection molding unit, prior to dispensing the molding material into the feed zone or while the molding material is in the feed zone.

14. The method of claim 13, wherein cooling the molding material includes cooling at least one of a feeding portion of the injection molding unit, configured for dispensing the molding material into the feed zone, or the feed zone to a temperature at or below the cooled temperature for the molding material.

15. The method of claim 14, wherein cooling the molding material includes cooling one or both of a hopper or a feed throat of the feeding portion.

16. The method of claim 13, wherein cooling the molding material includes cooling the molding material to a temperature at or below about 0° C.

17. The method of claim 13, wherein cooling the molding material includes mixing a cooling medium with the molding material.

18. The method of claim 17, wherein mixing the cooling medium with the molding material includes mixing liquid nitrogen with the molding material.

19. The method of the claim 17, wherein mixing of the cooling medium with the molding material comprises mixing the cooling medium with the molding material in a first hopper of the injection molding unit.

20. The method of claim 19, wherein the first hopper is positioned within a second hopper, the method further comprising conveying cooled molding material from the first hopper into a cavity within the second hopper.
